(19) United States
(12) Patent Application Publication
(10) Pub. No.: US 2010/0172776 A1
(43) Pub. Date: Jul. 8, 2010

(54) FUEL PUMP

(75) Inventors: Matthias Fischer, Datterode (DE); Christoph Schmidt, Rotenburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: CONTINENTAL AUTOMOTIVE GMBH, Hannover (DE)

(21) Appl. No.: 12/602,529

(22) PCT Filed: May 15, 2008
(86) PCT No.: PCT/EP2008/055973

§ 371 Date: Dec. 1, 2009

(30) Foreign Application Priority Data
Jun. 1, 2007 (DE) 10 2007 025 510.3

(51) Int. Cl. F02M 37/08; F04D 29/046

(52) U.S. Cl. 417/423.12; 417/410.1

(57) ABSTRACT

A fuel pump for delivering fuel has a housing part made from a coated material. An insert made from an electrically non-conductive material, such as for example phenolic resin, is pressed into the housing part. The insert which is produced from phenolic resin can be pressed into the housing part before a surface treatment of the housing part, since phenolic resin is not electrically conductive. As a result, the fuel pump can be produced particularly inexpensively.

### PRIORITY CLAIM

This is a U.S. national stage of application No. PCT/EP2008/055973, filed on May 15, 2008, which claims priority to the German Application No.: 10 2007 025 510.3, filed: Jun. 1, 2007, the content of both incorporated herein by reference.

### BACKGROUND OF THE INVENTION

1. Field of the Invention

The invention relates to a fuel pump for delivering fuel, having a housing part for mounting a pump stage, an electric motor for driving the pump stage, and having an insert fastened in the housing part, the housing part being produced from surface-treated metal.

2. Prior Art

Such fuel pumps are often used in modern motor vehicles and are known from practice for delivering fuel from a fuel tank to an internal combustion engine of the motor vehicle. In the case of the known fuel pumps, the inserts are usually produced from carbon or graphite. To produce the fuel pumps, the housing part is first worked and surface-treated by electric current. After the surface treatment, one or more inserts are fastened in the housing part and the entire subassembly is re-worked. This ensures that the inserts are neither included in the coating nor damaged by aggressive media or electric current in a bath used for the surface treatment. In particular, it has been found that carbon-containing inserts are destroyed during an anodizing process. However, fitting the insert after the surface treatment of the housing part means that the production of the fuel pump becomes very laborious. Moreover, the surface treatment of the housing part results in tolerances, an effect which is, for example, very troublesome for press-fitting the insert into the housing part. This surface treatment also often necessitates a subsequent treatment of fits.

### SUMMARY OF THE INVENTION

An embodiment of the invention addresses the problem of developing a fuel pump of the type mentioned at the beginning in such a way that it can be produced particularly inexpensively.

This problem is solved according to one embodiment of the invention by the insert having a surface of an electrically nonconductive material.

Being designed in this way allows the insert to be fastened in the housing part already before the surface treatment. Since the insert has a surface of electrically nonconductive material, the surface treatment does not lead to the insert being damaged or becoming coated. This obviates the need for the laborious fitting of the insert after the surface treatment of the housing part during the production of the fuel pump according to the invention. The pairing of the materials of the housing part and of the insert makes it possible according to the invention for a subassembly of more than one material to be sent for surface treatment and only desired components to be treated. The insert is not treated and also does not impair the surface treatment of the housing part. This makes the production of the fuel pump according to the invention particularly inexpensive.

The insert could, for example, have a coating of an electrically nonconductive material. However, it helps to make the production of the fuel pump according to the invention even less laborious if the insert is produced completely from electrically nonconductive material.

According to another embodiment of the invention, the insert is produced particularly inexpensively if at least the surface of the insert is produced from phenolic resin or electrically nonconductive plastic. It has been found in this respect that phenolic resin in particular has sufficient chemical stability with respect to the fuels and great strength during the operation of the fuel pump according to the invention.

It helps to further reduce the production costs of the fuel pump according to the invention if the housing part is produced from anodized lightweight metal.

With particularly low production costs, the fuel pump according to the invention has particularly small production tolerances if the insert is formed as a bearing bush for a shaft for driving the pump stage. According to one embodiment of the invention, the mounting of the shaft has particularly small tolerances, since impairment of the bearing bush during the surface treatment of the housing part is reliably avoided. Moreover, impairment of the seating of the bearing bush during the surface treatment is avoided, since the bearing bush is fastened to the housing part before the surface treatment. The small production tolerances with respect to the mounting of the shaft result in low wear and very smooth running.

### BRIEF DESCRIPTION OF DRAWINGS

The invention allows numerous embodiments. To further illustrate its basic principle, one of these is represented in the drawings and described below.

FIG. 1 schematically illustrates a partial section through a fuel pump according to one embodiment of the invention; and

FIG. 2 is a housing part of the fuel pump according to the one embodiment of the invention greatly enlarged in a sectional representation.

### DETAILED DESCRIPTION OF THE DRAWINGS

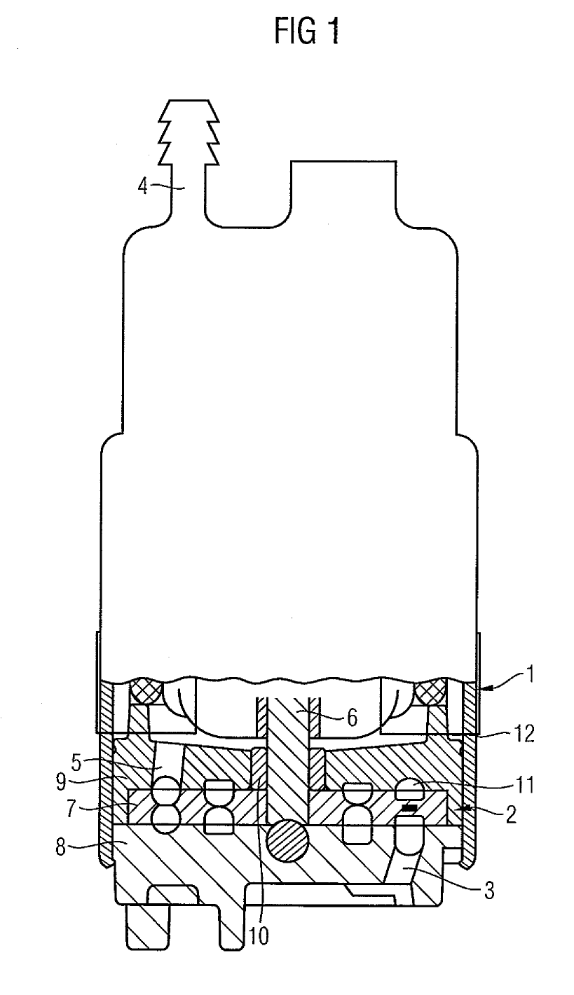

FIG. 1 is a fuel pump with a pump stage 2 driven by an electric motor 1. The fuel pump has an inlet 3, arranged in the pump stage 2, and an outlet port 4, arranged on the side of the electric motor 1 that is facing away from the pump stage 2. Fuel drawn in via the inlet 3 of the pump stage 2 is delivered to the outlet port 4 via an outlet 5 of the pump stage 2 by the electric motor 1. Connected to the outlet port 4 can be a feed line (not represented), leading to an internal combustion engine. The pump stage 2 has an impeller 7, fastened on a shaft 6 of the electric motor 1, and is formed as a side channel pump. The impeller 7 is held rotatably between two housing parts 8, 9 of the pump stage 2. For mounting the shaft 6, an insert 10 is fastened as a bearing bush in housing part 9. Housing part 8 has the inlet 3, while the housing part 9 has the outlet 5. The impeller 7 and the housing parts 8, 9 have delivery chambers 11 leading from the inlet 3 to the outlet 5. The fuel pump has a casing 12 of metal, which prestresses the housing parts 8, 9 against each other.

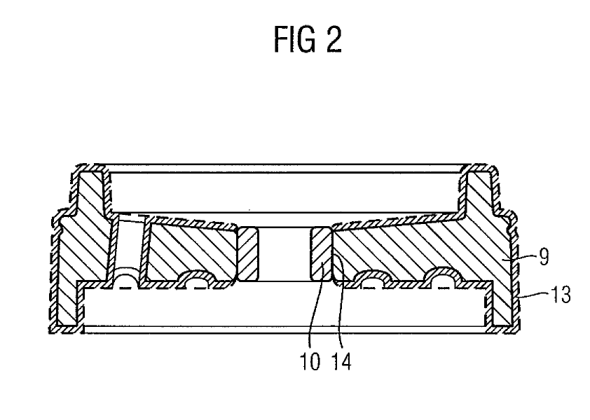

FIG. 2 shows the housing part 9 of the fuel pump from FIG. 1, having the insert 10, in a greatly enlarged form. The housing part 9 is produced from lightweight metal and has a coating 13. The insert 10 is press-fitted into a bore 14 of the housing part 8 and is produced from phenolic resin. The coating 13 has been applied to the housing part 9 by a surface treatment, for example an anodizing process, once the insert 10 has been press-fitted into the bore 14. Since phenolic resin is an electrically nonconductive material, the insert 10 has not been coated during the surface treatment. Likewise, the insert 10 is not damaged by the surface treatment, with the result that the subassembly formed by the coated lightweight metal and the insert 10 of phenolic resin is ready to be fitted in the fuel pump represented in FIG. 1 without any further subsequent treatment.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A fuel pump for delivering fuel, comprising:
a housing part produced from surface-treated metal configured for mounting at least one of a pump stage and an electric motor for driving the pump stage;
an insert fastened in the housing part, wherein the insert has a surface of an electrically nonconductive material.

7. The fuel pump as claimed in claim 6, wherein the insert is produced completely from an electrically nonconductive material.

8. The fuel pump as claimed in claim 7, wherein the electrically non conductive material is one of a phenolic resin and an electrically nonconductive plastic.

9. The fuel pump as claimed in claim 6, wherein the housing part is produced from a lightweight metal having an anodized surface.

10. The fuel pump as claimed in claim 6, wherein the insert is configured as a bearing bush for a shaft to drive a pump stage of the fuel pump.

10. The fuel pump as claimed in claim 6, wherein the insert is configured as a bearing bush for a shaft to drive a pump stage of the fuel pump.

11. The fuel pump as claimed in claim 6, wherein at least the surface of the insert is produced from one of a phenolic resin and an electrically nonconductive plastic.

12. The fuel pump as claimed in claim 7, wherein the insert is a bearing bush for a shaft configured to drive a pump stage of the fuel pump.

13. The fuel pump as claimed in claim 10, wherein the insert is a bearing bush for a shaft configured to drive a pump stage of the fuel pump.

14. A fuel pump for delivering fuel, comprising:
a housing part produced from surface-treated metal configured for mounting at least one of a pump stage and an electric motor for driving the pump stage, the housing part comprising at least one bore;
an insert fastened in the at least one bore of the housing part, wherein the insert has a surface of an electrically nonconductive material.

15. The fuel pump as claimed in claim 14, wherein the insert is a bearing bush for a shaft configured to drive the pump stage.

16. The fuel pump as claimed in claim 15, wherein the bearing bush is configured to be press fit into the bore.

17. The fuel pump as claimed in claim 14, wherein the electrically non conductive material is one of a phenolic resin and an electrically non conductive plastic.
